(19) United States
(12) Patent Application Publication
(10) Pub. No.: US 2005/0219689 A1
(43) Pub. Date: Oct. 6, 2005

(54) Microscope with retractable cord

(76) Inventors: David John Copeland, Milton, MA (US); Aidan John Petrie, Jamestown, RI (US); Robert J. Garay, San Jose, CA (US)

Correspondence Address: FISH & RICHARDSON P.C., PO BOX 1022, MINNEAPOLIS, MN, 55440-1022, US

(21) Appl. No.: 10/816,200

(22) Filed: Mar. 31, 2004

(51) Int. Cl. G02B 21/06

(52) U.S. Cl. 359/390; 359/368

(57) ABSTRACT

Systems and techniques relating to a microscope including a cord retractor. A microscope includes a base, a support arm attached to and extending upwardly from the base and a head attached to the support arm. The head includes at least one lens, and an eyepiece is attached to the head and in optical communication with the lens. A stage is positioned between the head and the base. The microscope further includes at least one electrically-powered component, and an electrical cord electrically connected to the at least one electrically-powered component. A cord retractor is positioned within the base, the cord retractor configured to retract at least a portion of the electrical cord into the cord retractor.

### BACKGROUND

The following description relates to a microscope including a cord retractor.

A microscope is an optical instrument that uses a lens or a combination of lenses to produce magnified images of small objects or specimens, especially specimens too small to be seen by the unaided eye. Depending on the size of the object or the purpose for viewing the specimen, different magnification levels may be desirable. A conventional microscope providing a range of magnification levels may include multiple tubes including one or more lenses, the tubes mounted on a rotatable nosepiece, such that the lens or lenses within an optical path can be changed by rotating the nosepiece, thereby changing the magnification level. The specimen may be placed on a stage beneath the lens or lenses and viewed by a user through an eyepiece.

A microscope typically includes an illuminator positioned beneath the stage to illuminate the specimen. The illuminator may be, for example, a light bulb or light emitting diode or diodes, and require a power source, which may be electricity, battery-power or a combination of the two. A microscope may require a power source for other features, such as an LCD display screen or digital camera.

### SUMMARY

Systems and techniques relating to a microscope including a cord retractor are described. In general, in one aspect, the invention features a microscope including a base, a support arm attached to and extending upwardly from the base and a head attached to the support arm. The head includes at least one lens, and an eyepiece is attached to the head and in optical communication with the lens. A stage is positioned between the head and the base. The microscope further includes at least one electrically-powered component, and an electrical cord electrically connected to the at least one electrically-powered component. A cord retractor is positioned within the base, the cord retractor configured to retract at least a portion of the electrical cord into the cord retractor.

Embodiments can include one or more of the following. The at least one electrically-powered component can include one or more of the following: an illuminator, an LCD display screen, a battery charger, or a digital camera. The cord retractor can be an automatic cord retractor configured to automatically retract the electrical cord into the cord retractor in response to a user input. Alternatively, the cord retractor can be a manual cord retractor configured to retract the electrical cord into the cord retractor in response to a manual winding action of a user.

Implementations may realize none, one or more of the following advantages. A cord retractor included within the base of a microscope can allow for storing the electrical cord such that the cord does not become kinked or bent, possibly damaging the cord. The automatic and manual cord retractors can be used remove excess electrical cord from a work or storage space, thereby reducing the likelihood of damage to the electrical cord, or items surrounding the electrical cord or microscope (e.g., lab materials on lab benchtop). When the microscope including a cord retractor is stored or being transported, the electrical cord is wound neatly inside the base of the microscope and is not left dangerously dangling from the microscope. Retracting the electrical cord into the base of the microscope can prevent the electrical cord from becoming entwined with other electrical cords or objects. An automatic cord retractor reduces the work required by a user to retract the electrical cord. A manual cord retractor advantageously may reduce the likelihood of the electrical cord being whipped around as the cord is being retracted into the microscope, which may damage the cord.

Details of one or more implementations are set forth in the accompanying drawings and the description below. Other features and advantages may be apparent from the description and drawings, and from the claims.

### DRAWING DESCRIPTIONS

These and other aspects will now be described in detail with reference to the following drawings.

FIG. 1 shows a perspective view of one implementation of a microscope with a retractable cord.

FIG. 2A shows a bottom view of a cord retractor.

FIG. 2B shows an exploded view of an automatic cord retractor.

FIG. 2C shows an electrical cord.

FIG. 3A show a microscope with a manual cord retractor.

FIG. 3B shows a bottom view of the microscope of FIG. 3A.

Like reference symbols in the various drawings indicate like elements.

### DETAILED DESCRIPTION

The systems and techniques described herein relate to a microscope including a cord retractor. A microscope may require a power source for a number of reasons, including powering an illuminator, an LCD display screen, a digital camera and/or other features included in the microscope. The power source may be electricity that is provided to the microscope by an electrical cord extending from the microscope and plugged into an external electrical outlet. Alternatively, the power source may be a rechargeable battery that can be recharged by an AC adapter included within the microscope and powered by electricity, again requiring an electrical cord to extend from the microscope to plug into an external electrical outlet.

A microscope having an electrical cord includes a cord retractor. Some or all of the electrical cord can be housed within the cord retractor, keeping excess cord out of the way when the microscope is in use, and storing all of the cord when the microscope is not in use. For example, an electrical cord may be three to six feet in length, although when in use, only a portion of the electrical cord may be required to extend from the microscope to an available electrical outlet. The excess electrical cord may remain within the cord retractor. A cord retractor may be “automatic”, meaning, for example, a cord can be automatically retracted into the cord retractor upon a user pressing a button or the like. Alternatively, a cord retractor may be “manual”, meaning a user manually retracts the cord into the cord retractor.

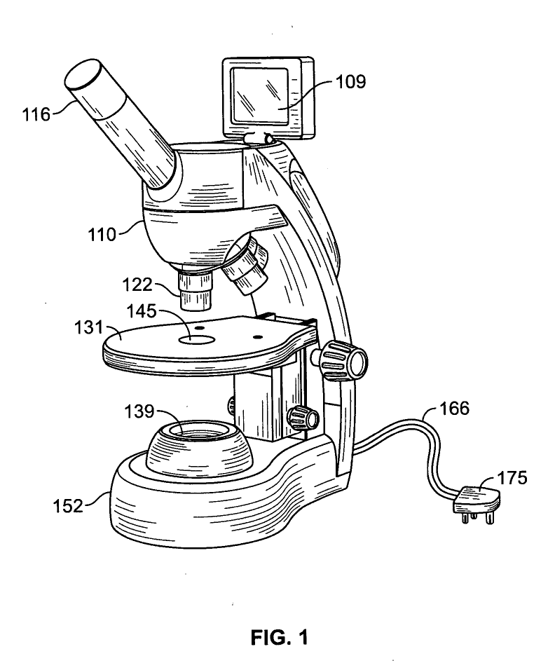

FIG. 1 shows one embodiment of a microscope 100 including a cord retractor. The microscope 100 depicted includes an LCD display screen 109 and an illuminator 139, both requiring electrical power. The electrical power is provided to the microscope by plugging the electrical cord 166 into an external electrical outlet. Other microscopes can include the cord retractor described herein, and the microscope 100 is just one example, described for illustrative purposes.

The microscope 100 includes a head 110 supporting an eyepiece 116 that is optically connected to a lens or combination of lenses 122. The lens 122 can magnify a specimen supported by a stage 131. Typically, a specimen, such as a specimen mounted on a slide, is at least partially transparent to light. The illuminator 139 is included within a base 152 and positioned below the stage 131. The illuminator 139 can direct light through an opening 145 in the stage 131, through the slide and into the lens 122. A user can view an image of the magnified specimen through either the eyepiece 116 or on the LCD display screen 109.

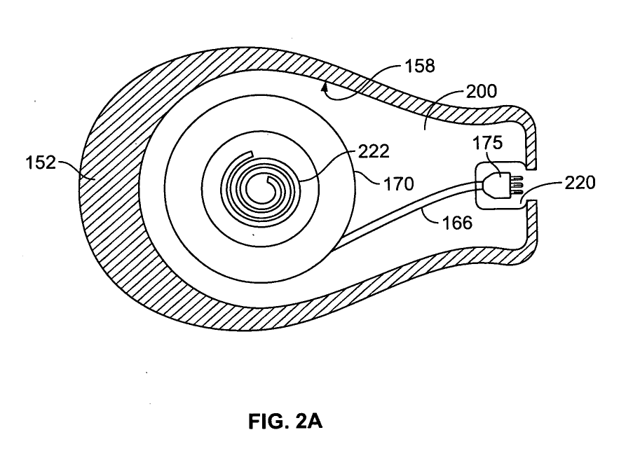

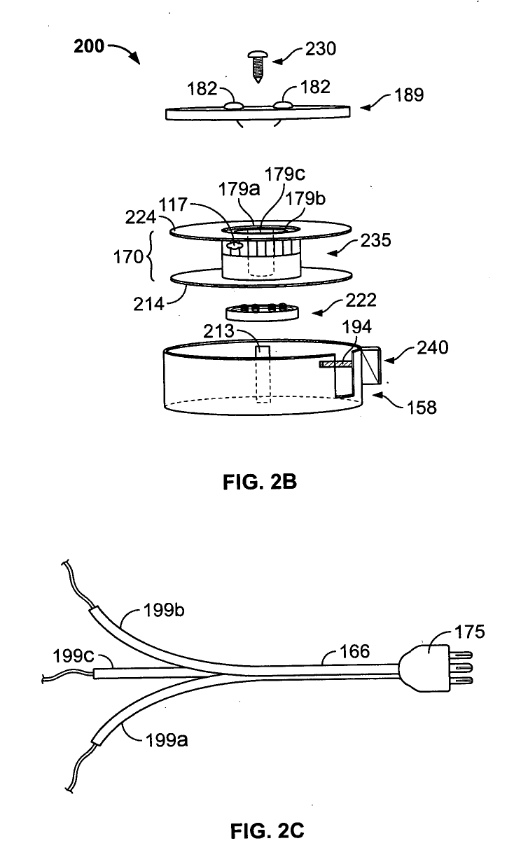

A cord retractor is included within the base 152. An automatic cord retractor can be implemented using conventional cord retractor mechanisms known in the art. Referring to FIGS. 2A and 2B, one example of an automatic cord retractor 200 is shown. FIG. 2A is a cross-sectional view of the base 152 including the cord retractor 200 with the electrical cord 166 in a fully retracted state. The cord retractor 200 includes a retractor housing 158 of sufficient size to house the entire length of the electrical cord 166 when the electrical cord 166 is in a fully retracted state. A distal end of the electrical cord 166 includes a plug 175, configured to mate with a standard electrical outlet. The retractor housing 158 includes a recess 220 for housing the plug 175, so that when the electrical cord 166 is in a fully retracted state, the prongs of the plug 175 do not extend outside of the base 152. The recess 220 can either be located on a side of the base 152 or on a bottom of the base 152. The recess 220 can be large enough so that a user can grasp the plug 175 to pull the electrical cord 166 out from the cord retractor 200.

The cord retractor 200 includes a spool 170 around which the electrical cord 166 is wound when the electrical cord 166 is in a retracted or semi-retracted state. A spring 222 is mounted within a recess in the spool 170, with one end of the spring 222 fixed to the spool 170 and the other end of the spring 222 fixed to the retractor housing 158. The retractor housing 158 includes a post 213 and the spring 222 is attached to the post 213, which post 213 extends up through the center of the spool 170. The spring can be similar to larger version of a watch spring, and be approximately a quarter inch in width, and one thirty-second of an inch thick and five to six feet long.

When the electrical cord 166 is extended from the cord retractor 200, the spring 222 is under tension so that the spring 222 attempts to rotate the spool 170, which would wind the electrical cord 166 around the spool 170. To maintain the electrical cord 166 in an extended state, that is, to stop the spring 222 from rotating the spool 170, the spool 170 includes a center portion 235 with a stepped profile. A pin 194 fixed to the interior of the retractor housing 158 can lock into each step of the spool 170, stopping the spring 222 from winding the electrical cord 166 back into the retractor housing 158. The stepped profile can be at regular intervals around the center 235 of the spool, e.g., every ⅛^{th} of a turn. As the electrical cord 166 is pulled out of the retractor housing 158, the spool 170 rotates causing the pin 194, at each interval, to fall into the next step and lock into place until the spool 170 is rotated enough to move the pin 194 into an adjacent step and so on.

The pin 194 can be connected to a retraction activator, such as a spring loaded push button mechanism 240, which moves the pin 194 away from spool 170 when depressed. When the pin 194 is moved far enough from the spool 170 to remove the force that stops the spring from 222 from unwinding, the spring 222 rotates the spool 170, thereby retracting the electrical cord 166 into the retractor housing 158. The retractor housing 158 and spool 170 can be formed from a material, such as injection molded plastic, the pin 194 and spring 222 can be of a material such as plastic or metal.

The proximal end 199 of the electrical cord 166 is electrically connected to electrical contacts housed within the spool 170. The electrical contacts can be concentric polarity rings 179a-c or cylindrical bodies that include a neutral contact, a hot contact and a ground contact. Referring to FIG. 2C, the electrical cord 166, such as a UL approved cable, includes three wires: a neutral wire 199a, a hot wire 199b and a ground wire 199c. The three wires are each insulated from one another and are attached to respective polarity rings 179a-c, e.g., by soldering or fastening with a screw, a metal clip or by wrapping the wire around the polarity ring 179. A hole 117 is formed in the center portion 235 of the spool 170, and proximal end 199 of the electrical cord 166 is passed through the hole 117 to connect to the polarity rings 179a-c.

In one embodiment, the neutral polarity ring 179a is closest to the spool 170, the hot polarity ring 179b is within the neutral polarity ring 179a and the ground is the centermost polarity ring 179c. Alternatively, the ground can be a central post rather than a ring. The polarity rings 179a-c freely rotate as the spool 170 is rotated. The polarity rings 179a-c are each made from a conductive material, such as metal.

In addition to a central portion 235, the spool 170 includes flat circular plate at either end of the central portion 235. One plate 214 can be adjacent to the bottom of the retractor housing 158, and the other plate 224 can be adjacent to a top cover plate 189. The cover plate 189 can lock into the retractor housing 158 so that the plate 189 does not rotate as the spool 170 rotates. The cover plate 189 includes electrical contacts 182 to the neutral and hot polarity rings 179a and b, such as two contact brushes, that are each aligned with a respective hot and neutral polarity rings 179a-b. The cover plate 189 can also include a ground connection, such as a brush or a screw 230. The ground connection is constructed to always be in electrical contact with the ground wire 199c. A conductive grease can be applied to each of the screw 230 and electrical contacts 182 to help maintain an electrical connection.

The electrical contacts 182 can be electrically connected to components of the microscope requiring electricity. For example, the electrical contacts 182 can be connected to an adaptor, which is configured for the type of microscope in which the cord retractor 200 is housed. The adaptor is electrically connected to the components of the microscope requiring electricity, such as the illuminator, LCD display screen or a digital camera. For example, for a microscope with a battery-powered illuminator, electricity is required to recharge the battery, so an AC battery adaptor can be used. If the microscope does not include a rechargeable battery, the adaptor can include a step down transformer that is selected for the illuminator for other electrical requirements of the microscope (e.g., an LCD display screen). Exemplary illuminators can include LEDs, halogen bulbs or tungsten bulbs. A switch can be included on the microscope to complete an electrical connection between the electrical contacts 182 and the component.

The electrical contacts 182 can be attached to the adaptor either with conductive wires or metal. If using conductive wire, one end of the wire can be soldered to, screwed to or wrapped around the electrical contacts 182, and the other end of the conductive wire can be electrically connected to the adaptor. If using metal, such as metal strips, the electrical contacts 182 can be held by pressure against the metal.

The above describes one example of an automatic retracting mechanism that can be used to implement a cord retractor in a microscope. However, other retracting mechanisms may be used.

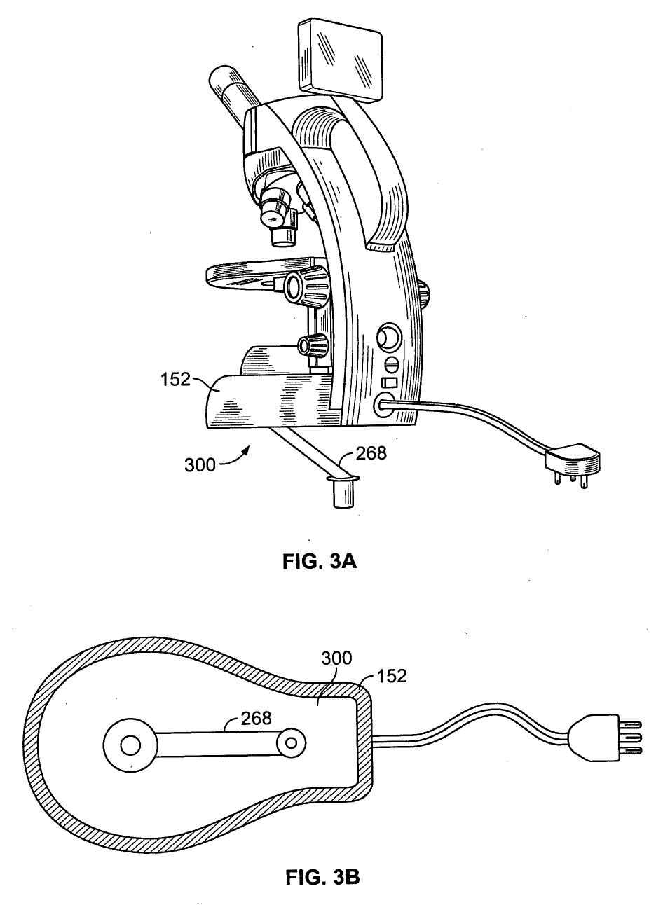

In another embodiment, a manual cord retractor can be used within a microscope to retract and house an electrical cord. A manual cord retractor can be implemented using conventional cord retractor mechanisms known in the art. Referring to FIG. 3A, an example of a microscope including a manual cord retractor 300 is shown. A bottom of the microscope is shown in FIG. 3B. The manual cord retractor 300 differs from the automatic cord retractor 200 in that the manual cord retractor 300 does not include a push button retraction activator, or a spring that causes the electrical cord 166 to retract into and wind around the spool 170. Other elements of the manual cord retractor 300 can be the same as the automatic cord retractor 200 shown in FIGS. 2A-B. That is, the manual cord retractor 300 also includes the retractor housing 158, spool 170 and electrical connections 182 described above. The main difference is that the manual cord retractor 300 includes a manually operated winding mechanism, such as a hand crank 268, for winding the electrical cord 166 into the retractor housing 158. The crank 268 can be attached to the flat circular plate 214 of the spool 170 as shown in FIG. 2B. As the crank 268 is turned, the plate 214 rotates the spool 170, causing the electrical cord 166 to wind around the spool 170. The crank 268 can be hinged, allowing the crank 268 to be folded into the retractor housing 158 or the base 152 when not being used, and unfolded to allow the crank 258 to be turned.

The automatic cord retractor 200 or manual cord retractor 300 can be removable from the base 152 for replacement. The base 152 can include a removable panel on either a bottom wall or a side wall of the base, such as by removing screws or releasing locking tabs formed into the base. Removing the removable panel exposes the cord retractor 200, which can then be removed. In one example, the retractor housing 158 or the cover plate 189 includes a track or locking mechanism that mates with a reciprocal track or locking mechanism in the base 152. The locking mechanism or track is disengaged before the retractor housing 158 can be removed from the base, such as by twisting or sliding the retractor housing 158 or cover plate 189.

Configuring the cord retractor for easy removal from the base 152 of a microscope 100, without the use of tools or having to physically break an electrical connection (e.g., a solder weld), the cord retractor can be easily replaced if a component of the cord retractor becomes damaged. For example, if the electrical contacts 182 include brushes that contact the polarity rings 179a-b, the retractor housing 158 and spool 170 can be removed from the base 152 by pulling away from the cover plate 189. The cord retractor can then be easily replaced once repaired, or may be entirely replaced, without soldering or replacing screws.

Although only a few embodiments have been described in detail above, other modifications are possible. Other embodiments may be within the scope of the following claims.

1. A microscope, comprising:
a base,
a support arm attached to and extending upwardly from the base;
a head attached to the support arm, the head including at least one lens;
an eyepiece attached to the head and in optical communication with the lens;
a stage positioned between the head and the base;
at least one electrically-powered component;
an electrical cord electrically connected to the at least one electrically-powered component; and
a cord retractor positioned within the base, the cord retractor configured to retract at least a portion of the electrical cord into the cord retractor.

2. The microscope of claim 1, wherein the at least one electrically-powered component comprises one or more of the following: an illuminator, an LCD display screen, a battery charger, or a digital camera.

3. The microscope of claim 1, wherein the cord retractor is an automatic cord retractor configured to automatically retract the electrical cord into the cord retractor in response to a user input.

4. The microscope of claim 1, wherein the cord retractor is a manual cord retractor configured to retract the electrical cord into the cord retractor in response to a manual winding action of a user.
